(19) United States
(12) Patent Application Publication
(10) Pub. No.: US 2002/0128906 A1
(43) Pub. Date: Sep. 12, 2002

(54) Marketing system

(76) Inventor: Stephen Belth, Chicago, IL (US)

Correspondence Address: Intellectual Property Group, Bose McKinney & Evans LLP, Suite 2700, 135 North Pennsylvania Street, Indianapolis, IN, 46204, US

(21) Appl. No.: 09/802,492

(22) Filed: Mar. 9, 2001

(51) Int. Cl. G06F 17/60

(52) U.S. Cl. 705/14

(57) ABSTRACT

A marketing system for communicating with an audience including a targeted individual a communication system. The marketing system includes a processor and a database accessible by the processor. The database including data related to the targeted individual and an identifier. In one embodiment the identifier is provided to the targeted individual. In another embodiment the identifier is known by the individual through a prior relationship. The marketing system further includes a plurality of audio recordings accessible by the processor. The processor is adapted to present the targeted individual with a resource including an audio component in response to the presentment of the identifier by the targeted individual. The audio component of the resource includes a selection of the audio recordings selected from the plurality of audio recordings. The audio recordings a generic portion and a tailored portion. The generic portion includes marketing information which is configured for the audience. The tailored portion is configured based on at least a portion of the data in the database related to the targeted individual.

### FIELD OF THE INVENTION

The present invention relates to marketing systems, and in particular to marketing systems including an audio component.

### BACKGROUND

The goal of the advertiser has always been to attract the attention of an audience and to maintain that attention during the message or advertisement. Traditional advertisements in newspaper and broadcasting have presented information to the audience on a mass basis. This can be best described as a “one-to-many” format, wherein one advertisement is delivered to many individuals. One of the limitations of such systems is that this mass advertising tries to identify the most common elements for appeal and does not account for an individual's unique characteristics. Mass advertising lacks any opportunity for personalization to be included in the message.

Advertising media, such as magazines, have begun to overcome the limitations of mass advertising with methods of targeting demographic characteristics of its audience. Using advances made in digital technology and computerization, magazine have attempted to make their advertising messages more specific to their readers through the selective inclusion of advertisements in a magazine subscription for home delivery, the selective inclusion being based on the demographic categories of the subscriber. For instance, subscriber A has an advertisement for a truck on page 10 of the magazine copy distributed to subscriber A while subscriber B has a different advertisement on page 10 of the magazine copy distributed to subscriber B. Such a system helps advertisers target an audience. Some magazines have even gone so far as to, provide personalized messages and advertisements on their covers, which address each audience member personally by name.

Another attempt to overcome this limitation is found in the creation of merged text messages sent out as mass direct mailings, such as sweepstakes entry forms or magazine renewal forms. These forms include a standard text message and information about each recipient is interlaced with the standard text message. These forms provide a one-to-one personalized presentation of information to members of the audience. However, direct mailings require active participation from the recipient, he must open the mailer and actively read it. As such, the forms are often discarded before they are read.

Another attempt is to provide each individual with an e-mail which directs the individual to a web page which is personalized to the individual. The personalized web page contains merged text similar to direct mass mailings and potentially interactive forms to be completed by the individual. However, such personalized web pages do not capture and retain the attention of the modem audience. In today's world, people have grown accustomed to receiving information through audio messages on the radio and audio and video information on the television.

Another attempt is to provide recorded telephone messages sent to each individual in the audience. Such systems allow the user to merge personal information with a standard text message. The system then uses a text-to-speech application to present the user with a computer generated audio message. However, such systems lack the warmth of a real human voice which includes multiple tones, inflections and the ability to stress certain portions of a message.

In view of these prior marketing systems, a need exists for a marketing system incorporating audio capability including recording of human voices which provides one-to-one personalized communication between an advertiser and the individuals within an audience.

### SUMMARY OF THE INVENTION

The present invention presents a targeted individual with an audio message including a portion which is tailored to the targeted individual.

In one exemplary embodiment, a marketing system for communicating with an audience including a targeted individual through a communication system includes a processor, a database accessible by the processor and a plurality of audio recordings. The database includes data related to the targeted individual and an identifier. The processor is adapted to present the targeted individual with a resource including an audio component in response to the presentment of the identifier by the targeted individual.

The audio component includes at least one generic portion and at least one tailored portion. The at least one generic portion includes at least one audio recording selected from the plurality of audio recordings and is configured to present the audience with a recording containing marketing information. The at least one tailored portion including at least one audio recording selected from the plurality of audio recordings configured based on at least a portion of the data in the database related to the targeted individual.

The audio component includes a first tailored portion corresponding to a name of the targeted individual included in the portion of data corresponding to the targeted individual. The first tailored portion includes an audio recording of the name of the targeted individual selected from the plurality of audio recordings. The audio component includes a second tailored portion based on a first value of a first characteristic of the targeted individual. The first value of the first characteristic is included in the portion of data in the database corresponding to the targeted individual.

In another exemplary a marketing system for communicating with a targeted individual includes a processor, a database accessible by the processor and a resource including an address and an input. The database includes data related to the targeted individual. The processor is adapted to present the targeted individual with a first media. The first media includes the address of the resource and at least a first portion of the data in the database related to the targeted individual including an identifier. The processor is further adapted to selectively present the targeted individual with a second media in response to the presentment of the identifier to the input of the resource. The second media including an audio message having at least one generic portion and at least one tailored portion. The at least one tailored portion configured based on at least a second portion of the data in the database related to the targeted individual.

In another exemplary embodiment, a marketing system for communicating with a targeted individual includes a processor, a database accessible by the processor and a resource including an input. The database includes data related to the targeted individual and an identifier. The processor is adapted to present the targeted individual with a media. The media includes a visual component and an audio component. The audio component having at least one generic portion configured to present the audience with marketing information and at least one tailored portion. The at least one tailored portion configured based on at least a portion of the data in the database related to the targeted individual.

In yet another exemplary embodiment, a marketing system for communicating with an audience of targeted individuals includes a processor connected to a communication system, a database accessible by the processor, and a resource including an input. The audience includes a first targeted individual and a second targeted individual. The database includes data related to a first targeted individual and a first identifier and data related to a second targeted individual and a second identifier. The processor is adapted to present the first targeted individual with a media configured for the first targeted individual. The media includes an audio component having an at least one generic portion configured to present the audience with marketing information and an at least one tailored portion. The at least one tailored portion configured based on at least a portion of the data in the database related to the first targeted individual. The processor is further adapted to present the second targeted individual with a media configured for the second targeted individual. The media includes a an audio component having an at least one generic portion configured to present the audience with marketing information and an at least one tailored portion. The at least one tailored portion configured based on at least a portion of the data in the database related to the second targeted individual.

In an exemplary method for marketing to a targeted individual, data is stored related to the targeted individual. The targeted individual is provided with a first media including an address and an identifier. The identifier is received from the targeted individual. The targeted individual is provided with a second media. The second media includes an audio message having at least one generic portion and at least one tailored portion. The at least one tailored portion configured based on the data related to the targeted individual.

Another exemplary method for marketing to a targeted individual includes the data related to the targeted individual including an identifier is stored. The identifier is received from the targeted individual. The identifier is verified by comparing the identifier to a database containing a plurality of known identifiers. The targeted individual is provided with a resource. The resource includes a visual component and an audio message having at least one generic portion configured to present the targeted individual with marketing information and at least one tailored portion. The at least one tailored portion configured based on a portion of data stored in the database and related to the targeted individual.

Additional objects, features and advantages of the invention will become apparent to those skilled in the art upon consideration of the following detailed descriptions of exemplary embodiments exemplifying the best mode of carrying out the invention presently perceived.

### BRIEF DESCRIPTION OF THE DRAWINGS

FIG. 1 is a block diagram of a marketing system which incorporates various features of the present invention;

FIG. 2 is a block diagram illustrating the components of the an exemplary embodiment of the present invention;

FIGS. 3 and 4 are a flowchart illustrating an exemplary method of operation for the system of FIG. 2;

FIG. 5 is a exemplary embodiment of the system of FIG. 2;

FIG. 6, is a first exemplary embodiment of a first media used in connection with the system of FIG. 2;

FIG. 7 is a first exemplary embodiment of a resource used in connection with the system of FIG. 2;

FIG. 8 is a second exemplary embodiment of a resource used in connection with the system of FIG. 2;

FIG. 9 is a block diagram of an exemplary embodiment of a second media used in connection with the system of FIG. 2;

FIG. 10 is a listing of two example database records used in connection with the system of FIG. 2;

FIG. 11 is a transcript representation of an exemplary embodiment of a second media used in connection with the system of FIG. 2;

FIG. 12 is the transcript of FIG. 11 sectioned into various generic and tailored portions;

FIGS. 13 and 14 are a flowchart illustrating an exemplary method of constructing the audio message of the second media;

FIG. 15 is a block diagram illustrating the components of the a second exemplary embodiment of the present invention;

FIG. 16 is a flowchart illustrating an exemplary method of operation for the system of FIG. 15; and

FIG. 17 is an exemplary embodiment of a resource used in connection with the system of FIG. 15.

### DETAILED DESCRIPTION OF EXEMPLARY EMBODIMENTS

While the invention is susceptible to various modifications and alternative forms, exemplary embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

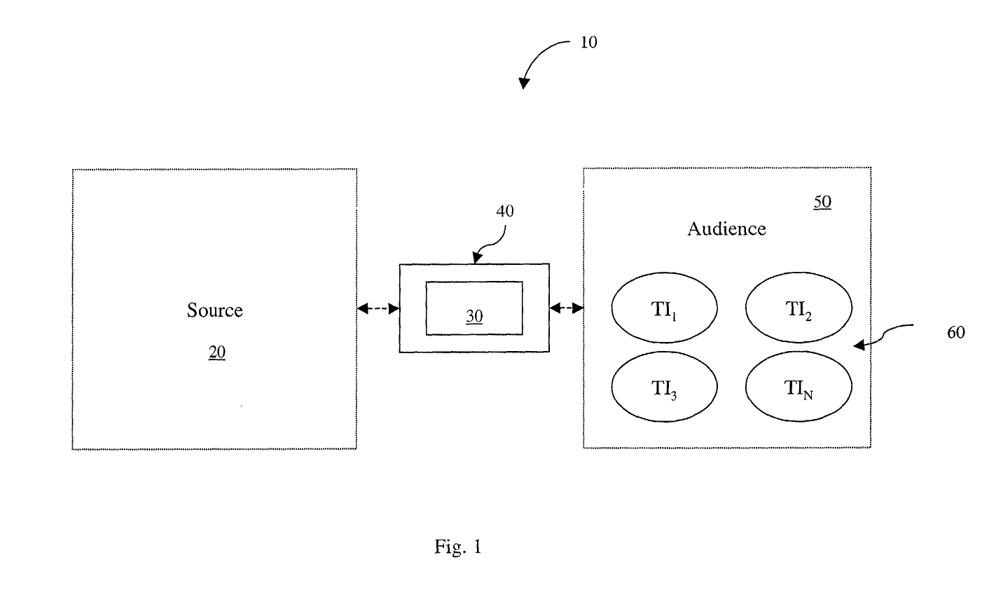

Referring to FIG. 1, a marketing system 10 includes a source 20, a message 30, and a communication system 40. Marketing system 10 presents an audience 50 with message 30 utilizing communication system 40. Audience 50 includes a group of targeted individuals 60, such as targeted individual (TI₁), targeted individual (TI₂), targeted individual (TI₃), and targeted individual (TI_{N}).

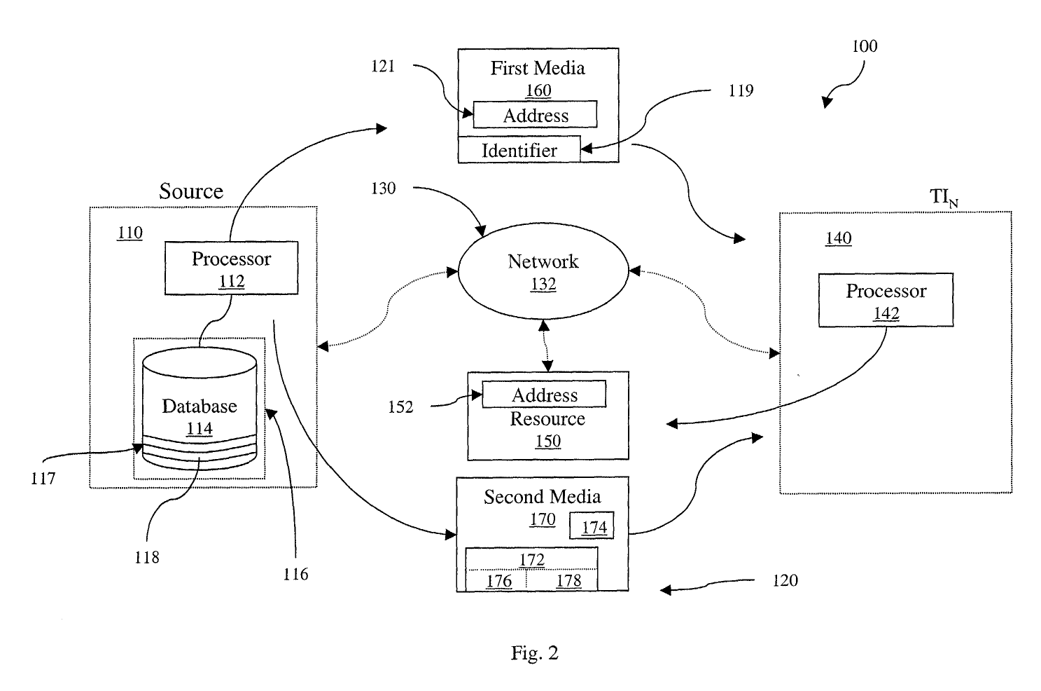

Referring to FIG. 2, an exemplary embodiment 100 of a marketing system 10 of the present invention is shown. Marketing system 100 includes a source 110, a message 120, and a communication system 130. Source 110 includes a processor 112 and a database 114 being accessible by processor 112. In an exemplary embodiment processor 112 is part of a personal computer. Alternatively, processor 112 is part of a server computer. In an exemplary embodiment database 114 is stored in a memory 116 accessible by processor 112. In one embodiment, database 114 is stored on the same computer as processor 112. Alternatively, database 114 is stored on the same local area network as processor 112. Alternatively, database 114 is stored in memory on a network accessible by processor 112.

Database 114 includes a plurality of records 117, each record pertaining to a separate targeted individual of audience 60. For example, record (TI_{N}) 118 corresponds to target individual (TI_{N}) 140. Each record contains an identifier 119. Identifier 119 is unique to the targeted individual associated with the record. Alternatively, identifier 119 is unique to a particular group of which the targeted individual is a member. As such, each individual which is part of a specific group has the same identifier stored in their database record. Alternatively, identifier 119 is unique to each targeted individual, but identifier 119 includes information pertaining to the group or groups that the individual is associated therewith. For example, a first portion of identifier 119 is configured to represent group information while a second portion of identifier 119 is configured to be unique to the individual. As such, the identifier “P1002” indicates that the targeted individual is a preferred customer, as represented by the “P,” and that the unique portion associated with the targeted individual is “1002.”

Communication system 130 is a network 132 that connects source 110 with members of audience 60 such as targeted individual (TI_{N}) 140. In one embodiment communication system 130 is a network of server computers, such as the Internet. Alternatively, communication system 130 is a local area network. Alternatively, communication system 130 is a cable network. In one embodiment, communication system 130 is connected to source 110 and audience 60, such as targeted individual (TI_{N}) 140 through a physical connection. Examples include a telephone modem or cable modem. Alternatively, communication system 130 is connected to source 110 and audience 60, such as targeted individual (TI_{N}) 140 through a wireless connection. An example of a wireless connection is a cellular connection similar to cellular phone technology.

Marketing system 100 includes a resource 150 accessible by communication system 130. Resource 150 provides information to audience 60, such as targeted individual (TI_{N}) 140 and is capable of receiving input from audience 60, such as targeted individual (TI_{N}) 140. Resource 150 is located on a computer or other processing device which is connected to communication system 130 and communicates with source 110 and targeted individual (TI_{N}) 140 over communication system 130. Alternatively, resource 150 is located within memory 116 which is accessible by processor 112.

In an exemplary embodiment, resource 150 includes an address 152 and is a web page which is accessible with a web browser through communication system 130. Alternatively, resource 150 is a program which is accessible or downloadable across communication system 130. Alternatively, resource 150 is a CGI script, an Active Server Page, or other generated web page.

Referring to FIGS. 2-4, an illustrative embodiment is provided for the operation of marketing system 100. In step 202 information related to audience 60 including information related to targeted individual (TI_{N}) 140 is collected. Information can be collected in a variety of different ways. For example, a company might supply their customer list and customer information or a club might provide their membership list and membership information or a marketing company might supply their list of potential customers or customer information.

At step 204, the system determines whether the information gathered includes an identifier for each audience member for whom information was collected. Typically, the identifier will be the individual's customer number, membership number, or personal identification number associated with the account. Alternatively, the system can assign an identifier to each individual as shown in step 206. Once the identifier has either been created or detected, the information is stored in a database file for future access by processor 112, as shown in step 208.

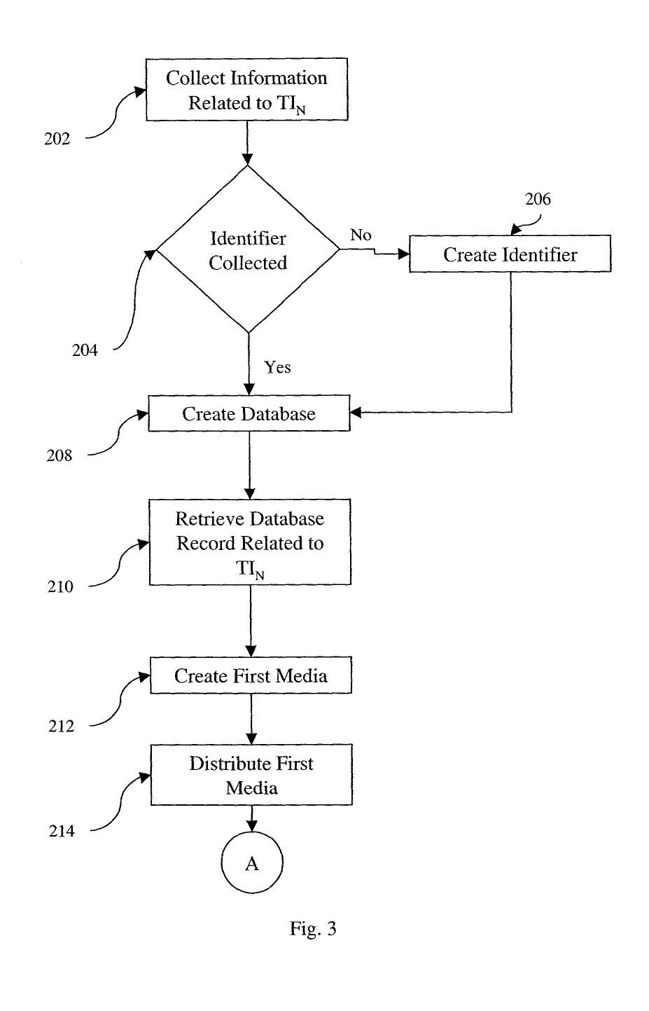

After database 114 has been created at step 208, a first media 160 is sent to each selected member of the audience, as shown in steps 210, 212 and 214. It is within the scope of the present invention to send first media 160 to all members of the audience or a selected group of the audience members. In step 210, information related to the targeted individual 140 is retrieved from the appropriate database record. For example, information related to targeted individual (TI_{N}) 140 is retrieved from record 118. Such information, might include all available information or a subset thereof, such as the name of the individual, the identifier, and the e-mail address of the individual. Once the appropriate information is retrieved, first media 160 is created, as illustrated by step 212. One method of creating first media 160 is to perform a merge text operation in an application software package, such as a database application like Microsoft® Access or a wordprocessor like Microsoft® Word. Once the individual first media are created, they are delivered to the targeted individuals through the postal system. A second method of creating first media 160 is to generate an e-mail to each targeted individual. The e-mails are created using a standard merge operation, similar to that used for word processing applications. The e-mails are then sent to the e-mail addresses associated with their respective targeted individual. The distribution of first media 160 is illustrated in step 214 of FIG. 3.

First media 160, along with information relating to the respective targeted individual, includes an address 121. Address 121 corresponds to address 152 of resource 150. As such, upon receiving first media 160 targeted individual 140 is able to easily access resource 150 over communication system 130. Alternatively, first media 160 includes identifier 119 and address 121. First media 160 includes identifier 119 in situations wherein the system assigned the identifier to the targeted individual in step 206. As such, the identifier must be communicated to the targeted individual because the targeted individual has no previous knowledge of the content of identifier 119. First media 116 does not include identifier 119 in situations wherein the targeted individual already knows identifier 119 through an existing relationship, such as a membership number, or in situations wherein the targeted individual selects their own identifier by entering the chosen identifier at resource 150. In one exemplary embodiment, the targeted individuals are prompted to select an identifier, such as a password, for future access to marketing system 100.

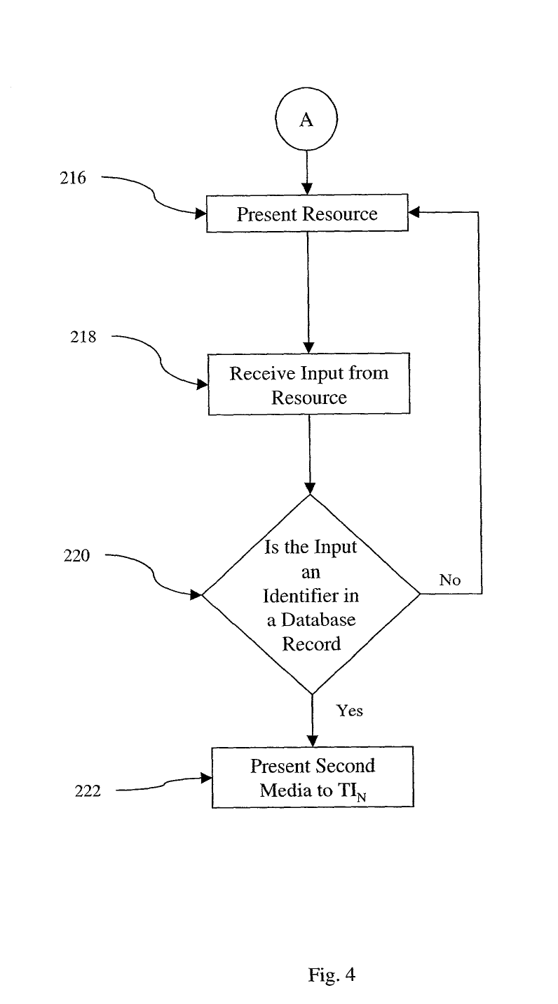

Referring to FIGS. 2 and 4, once targeted individual 140 receives first media 160, they have the address for resource 150. Targeted individual 140 enters address 121 into a web browser which is running on a processor 142. Processor 142 is connected to communication system 130. The web browser communicates address 121 to communication system 130 which in turn redirects the web browser to resource 150 which has address 152. Address 152 being identical to address 121. As such, targeted individual 140 is presented with the content of resource 150, as illustrated in step 216.

Once at resource 150, targeted individual 140 inputs identifier 119. The entered identifier is passed onto processor 112 through communication system 130, as illustrated in step 218. The entered identifier is then compared to the plurality of identifiers stored in database 114, as illustrated in step 220. If the identifier does not match one of the identifiers in database 114, resource 150 is presented to targeted individual 140 again. Resource 150 might further include a text message stating that the identifier was not verified. If the identifier matches one of the identifiers in database 114, marketing system 100 presents targeted individual 140 with a second media 170, as illustrated by step 222.

Second media 170 includes an audio component or portion 172. Alternatively, second media 170 includes an audio component or portion 172 and a visual component or portion 174. Audio portion 172 includes a generic portion 176 and a tailored portion 178. The combination of generic portion 176 and tailored portion 178 produces an audio message which is personalized to targeted individual 140. For example, second media 170 could be an advertisement for new mutual fund. The fund company wants to present a personalized message to each targeted individual. The second media could address each targeted individual by name and relate other information about the targeted individual. Both generic portion 176 and tailored portion 178 can be segmented into multiple sub-portions which are then interlaced to form the complete audio component 172 of second media 170.

Generic portion 176 and tailored portion 178 are created by recording an announcer reading the transcripts for each. The recordings are stored in memory 116 along with additional generic portions and tailored portions. It should be understood that generic portion 176 and tailored portion 178 correspond to recordings that were selected from a larger quantity of recordings. Different tailored portions and possibly different generic portions would be selected for a second targeted individual. As such, second media 170 is created by selecting the appropriate generic portions 176 and tailored portions 178 for targeted individual 140.

Marketing system 100, in one exemplary embodiment, presents personalized messages 120 through the Internet to members of an audience 60. The audience members utilizing an Internet capable device, such as a personal computer or personal data assistant, retrieve their personalized messages. Alternatively, members of an audience 60 are presented their personalized messages through a kiosk. For example, an audience member would provide their identifier to a processor in a kiosk at a department store. The system 100 would then present the audience member with message 120.

Alternatively, marketing system 100, presents messages 120 to members of an audience 60 through an ATM machine. The audience member inserts their ATM card into the ATM machine and then enters their PIN or identifier. The ATM machine then supplies the identifier to the network to which the ATM is connected. A processor on the network or within the ATM then constructs message 120 based on the information stored about the audience member in a database 114 accessible by the processor. Alternatively, marketing system 100 is used with gas pumps at a gas-station, such as the “easy pay” system at Shell Oil gas stations.

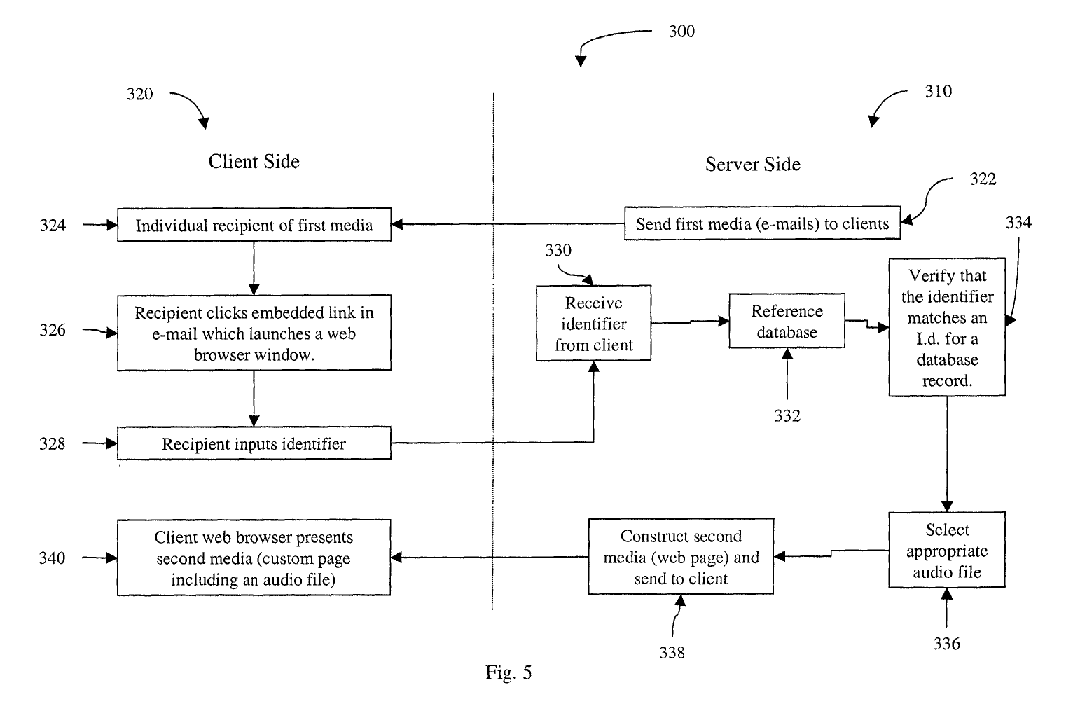

Referring to FIG. 5, another embodiment 300 of a marketing system 10, 100 is shown for implementation across the Internet. The source 20, 110 includes a server 310 having a processor which is capable of accessing a database 114 containing information related to an audience 60. Audience 60 is composed of a plurality of targeted individuals. Each targeted individual has access to the Internet through a client computer 320. Server 310 is connected to the Internet either directly or through an additional processing device (not shown). In step 322, server 310 sends a first media 160 to the targeted individuals which comprise audience 60. Each recipient, targeted individual, receives the e-mail in their e-mail account on client computer 320, as illustrated in step 324. The e-mail contains an embedded link or address 121 which when selected launches a web browser on client computer 320 and redirects the web browser to the resource 150 which corresponds to the link or address, as illustrated by step 326.

Once at resource 150, using client computer 320 the recipient or targeted individual, inputs identifier 119 received in the first media or e-mail, as illustrated in step 328. Alternatively, first media 160 does not contain an identifier but instead the targeted individual already knows their unique identifier 119 based upon their relationship with the source 20, 110. Alternatively, identifier 119 will simply be the name of the targeted individual. As such, the targeted individual will input their name into the appropriate location in the resource 150.

As illustrated in step 330, server 310 receives the identifier entered by the targeted individual. Server 310 then references a database 114 containing the listing of identifiers, as illustrated by step 332. The received identifier is then compared to the list of identifiers to determine which database record corresponds to the targeted individual submitting the identifier, as illustrated in step 334. Once the appropriate database record has been determined, server 310 selects the appropriate audio files required for a second media 170, 380 to present to the targeted individual over client computer 320, as illustrated in step 336. The selected audio files along with a visual component are configured into second media 380, such as a web page, as illustrated by step 338. Second media 380 is presented to the targeted individual on client computer 320, as illustrated by step 340.

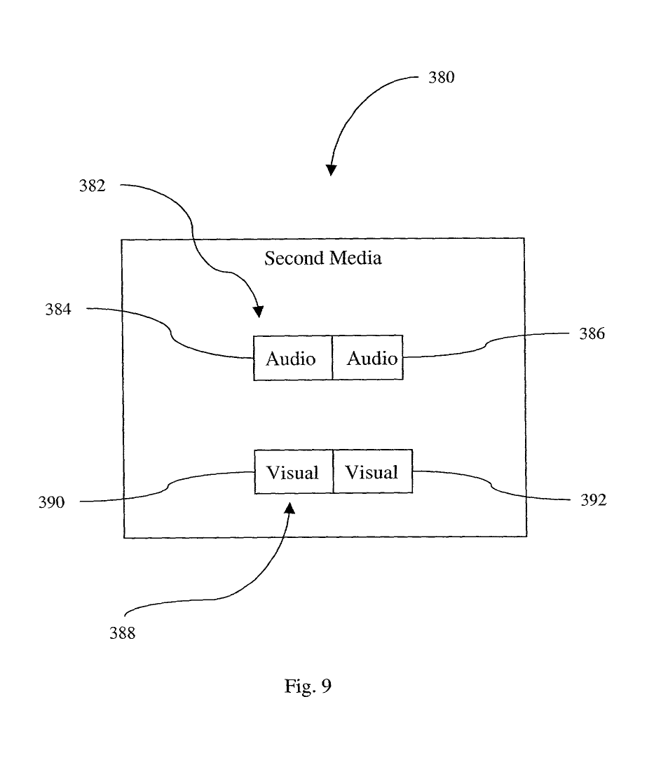

The selected audio files form an audio component 382 of a second media 380, as represented in FIG. 9. Audio component 382 consists of multiple recordings, some of which are generic and are part of generic components 384 and others which are tailored to the targeted individual and are part of tailored component 386. By having multiple recordings in both generic component 384 and tailored component 386, audio portion 382 presents the targeted individual with an integrated message that is personalized to the targeted individual. In one embodiment, the recordings of generic component 384 and tailored component 386 include the recording of a human announcer reading the text for each component. A human announcer is preferred to computer generated speech because of the natural characteristics of the human voice, such as inflection and tone.

Having multiple recordings overcomes the problems associated with having only a single generic recording and a single tailored recording. In such a case, the generic component recording includes portions wherein the announcer is speaking and portions of silence or only background sound, such as music. The tailored component recording includes portions wherein the announcer is speaking and portions of silence or only background sound, such as music. When both the generic and tailored portions are played at the same time the timing of the portions is such that when the announcer is speaking in the generic portion recording, the announcer is not speaking in the tailored portion recording, and vice versa. As such, the generic portion and the tailored portion when played simultaneously create a personalized message. However, such a configuration reduces the effectiveness of the overall system because the silent portions must be different for various targeted individuals. For example, the duration of the silent portion of the generic component recording for the announcer on the tailored component recording to say the name “Ray” is definitely different than the duration required to say the name “Sylvester.” Providing a duration long enough to accommodate “Sylvester” will leave an awkward pause when the targeted individual is named “Ray” instead.

In an exemplary embodiment, second media 170, 380 is created with an active server page and with a web design tool, such as Flash available from Macromedia, Inc. located at 600 Townsend Street, San Francisco, Calif. 94103. The second media is created using the Macromedia Flash application as follows. The targeted individual submits the identifier. The processor which receives the identifier will then point to an active server page (ASP) which reads the identifier and query an SQL database which returns information about the targeted individual. The active server page then redirects the targeted individual to a resource containing a flash movie. The Flash movie then performs a load variable action in the first keyframe to obtain the data generated by the ASP.

The Flash movie consists of multiple layers. The first audio layer includes the recordings which compose the generic portion of the audio component of the second media. If more than one generic portion is included in the second media then the recordings are spaced such that keyframes such as a stop keyframe and a go keyframe are inserted with each generic portion. For instance, a generic portion containing the recording, “Greetings,” would have a stop action in the first keyframe of layer one and a go action in the second keyframe of layer one. When the Flash movie is executed, the stop action keyframe tells the processor not to play layer one. Therefore, the Flash movie at the appropriate time directs the processor to execute keyframe two of layer one. The go action in keyframe two tells the processor to process the following sound file and will point the processor to the sound file associated with the recording, “Greetings.” Alternatively, the sound file will be loaded directly into the Flash movie at keyframe three in layer one. At the end of the sound file a stop action is included to stop the playing of the content of layer one. Alternatively, if a stop action is included before the beginning of the sound file the movie can reset to beginning of the sound file.

Once the sound file associated with, “Greetings,” has played the flash movie includes a tell target action which will direct the movie to the next sound file to be played. In one embodiment, the tell target action is passive in that its commands are based on the data retrieved by the ASP and no logic is performed. One example is in the case of the name of the targeted individual. The tell target action is created to simply point to the sound file associated with the name of the individual located in layer two. In a one embodiment, the tell target action points to a go keyframe in layer two positioned before the load point of the sound file corresponding to the name of the targeted individual. As such, the tell target is name independent, it simply redirects the processor to the location which is preceding the name. In a second embodiment, the tell target action, is active in that it contains logic to decide whether to include a specific sound file or which one of a plurality of sound files to include. For example, the tell target action includes the logic if targeted individual is a preferred customer and has requested third party offers then redirect the processor to keyframe twenty in layer two and play the associated special offer sound file.

In an exemplary case, wherein the targeted individual is to be presented with the following message, “Greetings, [name] [As a preferred customer] we would like to offer you the chance to win a new car,” the flash movie logic is as follows. The first generic portion is the recording associated with the word “Greetings.” The second generic portion is the recording associated with the phrase, “we would like to offer you the chance to win a new car.” Both generic portions are presented to all targeted individuals. The first tailored portion is the recording associated with the name of the targeted individual as indicated by the placeholder [name]. The second tailored portion is the recording associated with the status of the targeted individual as a preferred customer as indicated by the placeholder [As a preferred customer]. The first tailored portion is presented to all targeted individual but potentially has a different recording based upon the name of the targeted individual. The second tailored portion is presented only to targeted individuals which are also preferred customers.

The first generic portion is loaded into layer one of the Flash movie and has a go action preceding it and a tell target action after it. The second generic portion is loaded into layer one of the Flash movie and has a go action preceding it and a tell target action after it. The first tailored portion is loaded into the second layer of the Flash movie and has a go action preceding it and a tell target action after it. The second tailored portion is loaded into layer two and has a go action preceding it and a tell target action after it. Alternatively, all portions are loaded into the same layer. Alternatively, each portion is located in a separate layer.

The audio message is presented in the following manner. The movie encounters the go action before the first generic portion and plays the sound file following the go action. The tell target action at the end of the sound file redirects the movie to the go action associated with the first tailored portion. The sound file associated with the first tailored portion is played. The tell target action at the end of the sound file associated with the first tailored portion redirects the movie to the go action associated with the second tailored portion if the targeted individual is a preferred customer, as determined based on the data collected by the ASP. If the targeted person is not a preferred customer, then the tell target action redirects the movie to the go action associated with the second generic portion. The sound file associated with the second generic portion is then played. Finally, at the end of the second generic portion, the tell target action redirects the movie back to the beginning of the movie, a stop action located in keyframe one of the first layer.

The foregoing example is simply one example of how the marketing system is implemented using the Flash application. Alternative methods of implementation exist both within Flash and using other applications such as Generator from Macromedia.

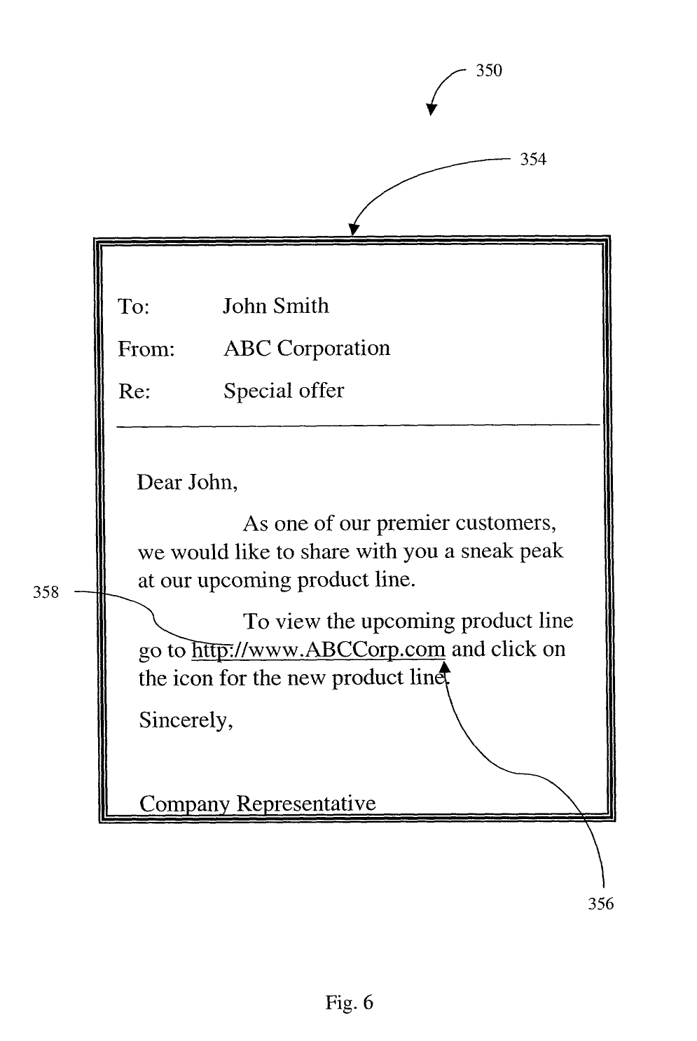

Referring to FIG. 6, an exemplary embodiment of a first media 350 of marketing system 300 is shown. First media 350 is an e-mail 354 which is sent to a targeted individual 352 named John Smith. E-mail 354 is sent from the ABC Corporation and is promoting a special offer. First media 350 is created through conventional merging techniques. The targeted individual's e-mail address and first name are pulled from the appropriate database record and placed in e-mail 354 at the appropriate locations. First media 350 contains an embedded link 356 which corresponds to an address 358 of a resource 360. It should be noted that first media 350 does not contain an identifier. As such, first media 350 is exemplary of situations wherein the targeted individual already knows their identifier.

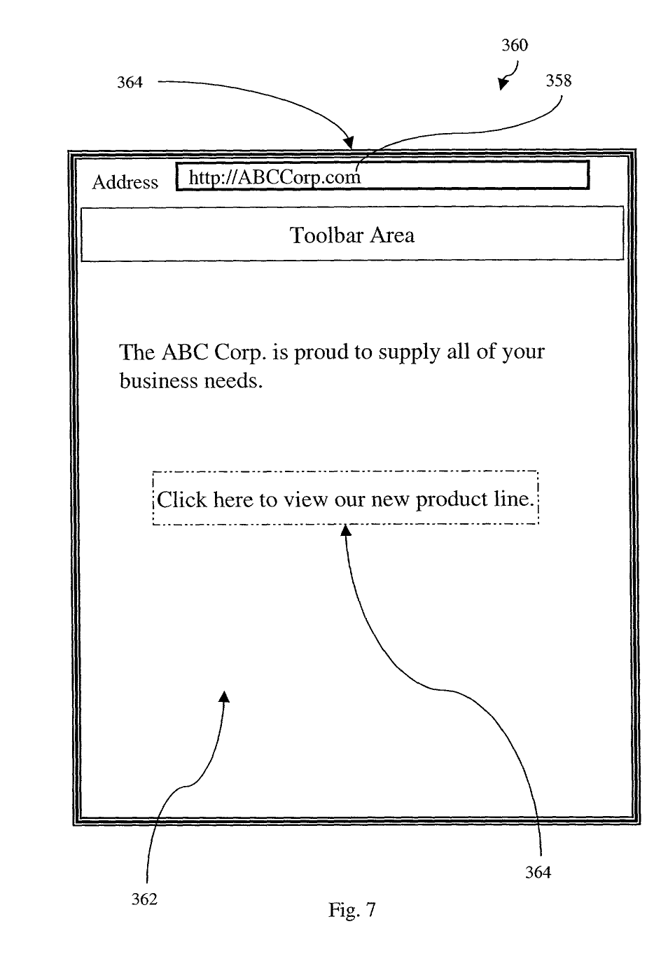

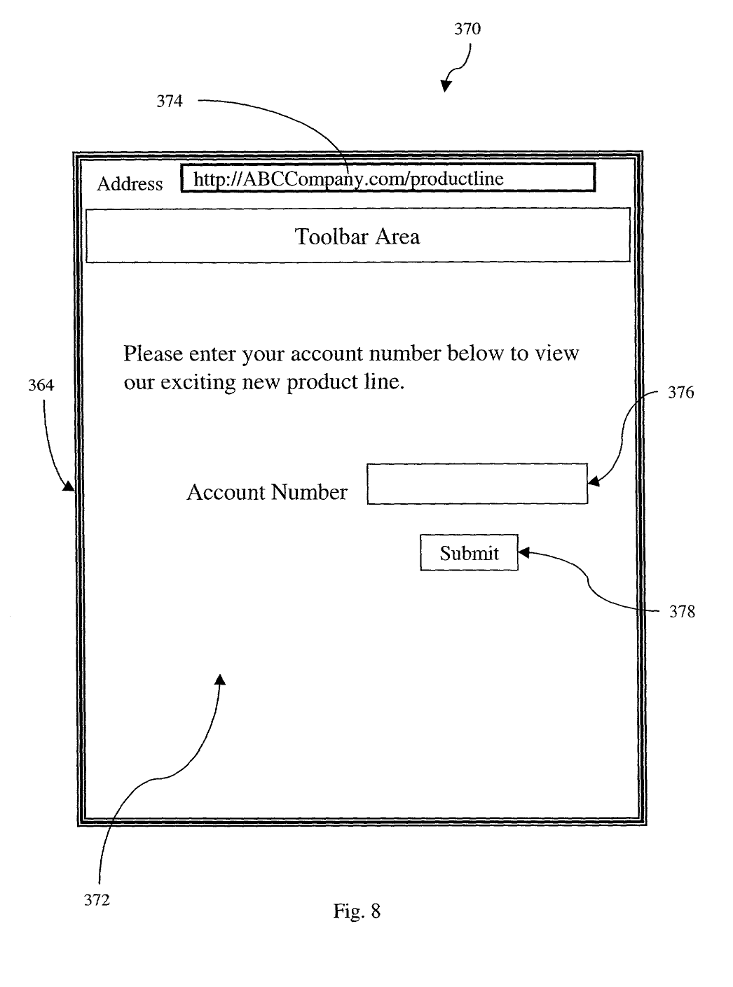

Referring to FIG. 7, an exemplary embodiment of resource 360 is shown. Resource 360 is a web page 362 which is displayed using a web browser 364 on client computer 320. As shown in FIG. 7, address 358 corresponds to web page 362. Web page 362 includes a link 364 to a second resource 370. An exemplary embodiment of second resource 370 is shown in FIG. 8. Second resource 370 is a web page 372 viewable using web browser 364. Web page 372 includes an address 374 and an active entry location 376. The recipient or targeted individual enters their identifier in the active entry location 376. After the identifier is entered the recipient or targeted individual submits their identifier by clicking a button 378 with a mouse associated with client computer 320 or by depressing the enter key on the keyboard associated with client computer 320. Alternatively, the recipient submits the identifier by any acceptable method, such as touching a submit area on a touch sensitive screen or by pressing a button adjacent the submit option on a screen similar to an ATM machine. Once server 310 verifies that the identifier submitted is correct, server 310 presents the targeted individual with a second media 380 as shown in FIG. 9.

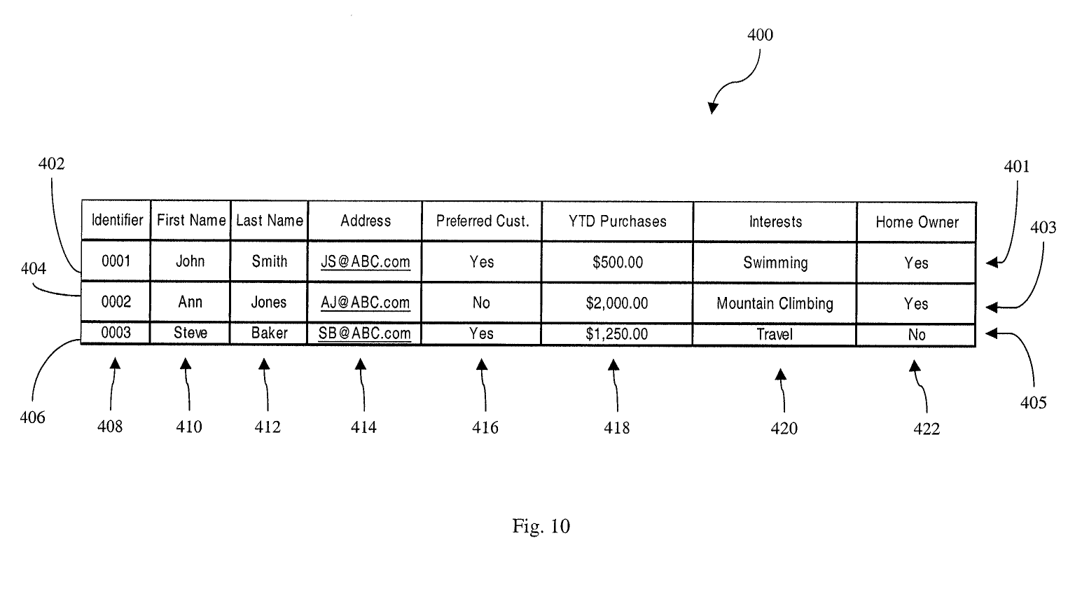

Referring to FIG. 9, second media 380 includes an audio component or portion 382. Audio portion 382 includes a generic portion or component 384 and a tailored portion or component 386. Generic component 384 includes a recording of a text message that is not specific to any one targeted individual or any one sub-set of the audience. An example generic component recording is “Please come see our exciting new selection of cars. We are located at . . . .” Tailored component 386 includes a recording of a text message that is specific to a targeted individual or a sub-set of the audience. A first example of a tailored component is “Steve.” A second example of a tailored component is “As a frequent flyer participant you are entitled to an additional ten percent discount.” Preferably, generic component 384 and tailored component 386 include multiple recordings, as explained in connection with FIGS. 10-12.

By having multiple recordings in both generic component 384 and tailored component 386, audio portion 382 presents the targeted individual with an integrated message that is personalized to the targeted individual. Preferably, the recordings of generic component 384 and tailored component 386 include the recording of a human announcer reading the text for each component. A human announcer is preferred to computer generated speech because of the natural characteristics of the human voice, such as inflection and tone.

Second media 380, in one embodiment, further includes a visual component or portion 388. Visual portion 388 includes one or more visual images. Example visual images include video clips, animation, text, and clip-art. Visual portion 388, in one embodiment, includes a generic component 390 and a tailored component 392. Generic component 390 includes a visual image that is not specific to any one targeted individual or any one sub-set of the audience. Tailored component 392 includes a visual image that is specific to a targeted individual or a sub-set of the audience.

Visual component 388, in one embodiment, is based upon the audio component 382. For example, video component 388 presents images or movies or text which coincides with the text of the audio component 382 or which supplement audio component 382. Additionally, video component 388 presents the audience with the opportunity to be directed to another resource, such as a web page designed to process online orders.

Referring to FIGS. 10-12, second media 380 is based upon the database information corresponding to a targeted individual. In FIG. 10 a portion of a database 400 including three exemplary database records 400, 402, and 404 are shown, each record 400, 402, 404 corresponding to a separate targeted individual 401, 403, and 405, respectively. In the exemplary embodiment each record 402, 404 and 406 contains characteristics such as an identifier 408, a first name 410, a last name 412, an address 414, and additional characteristics 416, 418, 420, and 422. In the exemplary embodiment characteristic 416 relates to whether the corresponding targeted individual 401, 403, and 405 is a preferred customer. In the exemplary embodiment characteristic 418 relates to the year-to-date (YTD) purchase of the corresponding targeted individual 401, 403, and 405. In the exemplary embodiment characteristic 420 relates to a personal interest of the corresponding targeted individual 401, 403, and 405. In the exemplary embodiment characteristic 422 relates to whether the corresponding targeted individual 401, 403, and 405 is a home owner.

The various components 408, 410, 412, 414, 416, 418, 420 and 422 of records 402, 404, and 406 are used to create a personalized audio portion 382 for targeted individuals 401, 403, and 405. Additionally, components 408, 410, 412, 414, 416, 418, 420 and 422 of records 402, 404, and 406 are used to create a personalized visual portion 388 for targeted individuals 401, 403, and 405. The components 408, 410, 412, 414, 416, 418, 420 and 422 of records 402, 404, and 406 are used individually or in combination to determine the content of audio portion 382 and visual portion 388. In a first illustrative example, first name 410 is utilized along with identifier 408 to determine that the first name of targeted individual 401 is “John.” In a second illustrative example, characteristics 416 and 418 are utilized to determine if any of targeted individuals 401, 403, or 405 are a preferred customer and have year to date purchases of greater than one thousand dollars. Targeted individual 405 meets the two stated criteria. As such, in one embodiment, targeted individual 405 is presented with a special message in second media 380.

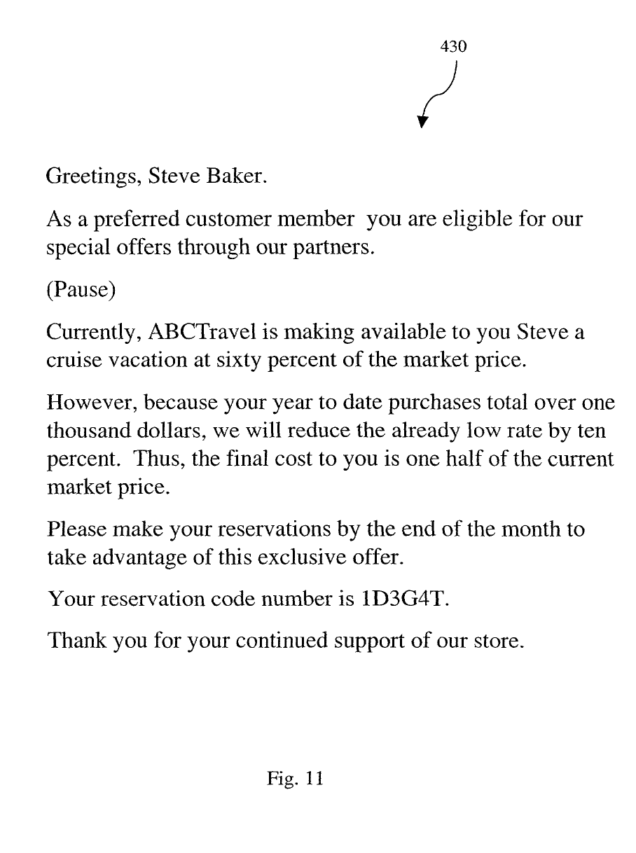

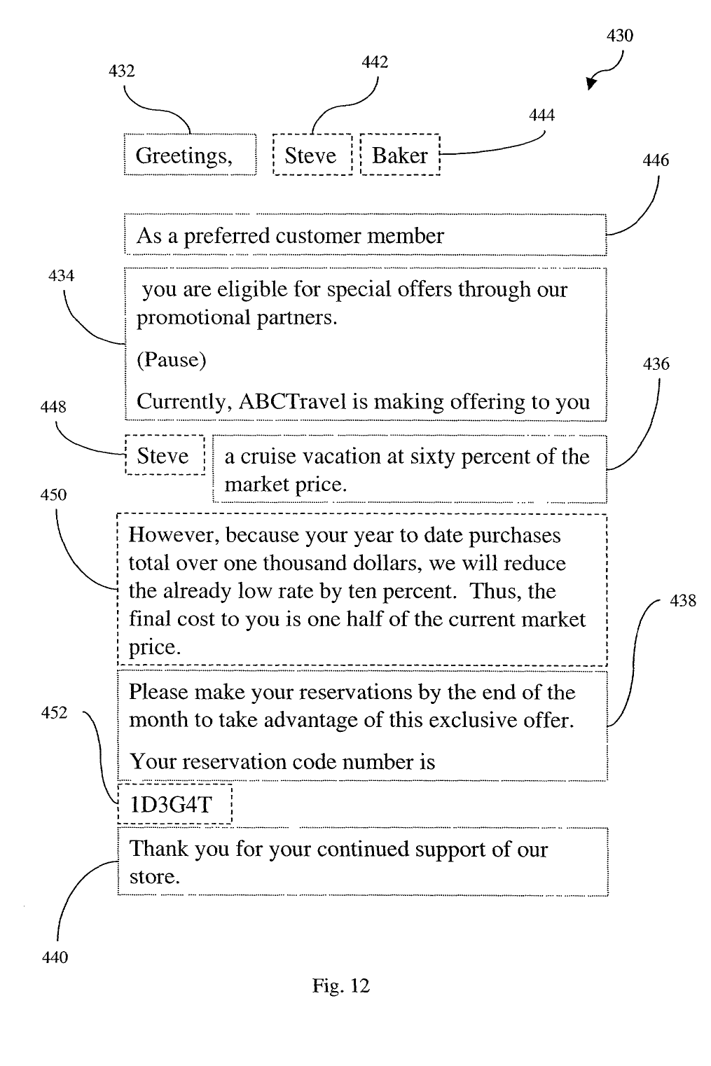

FIG. 11 shows a transcript of an exemplary message 430 of audio portion 382 of second media 380 sent to Steve Baker, targeted individual 405. Message 430 is composed of tailored audio messages selected based on the information located in database record 406, which corresponds to the identifier 408 entered at client computer 320, and generic portions 384 of audio portion 382. FIG. 12 shows the transcript of message 430 with the generic components and tailored components identified. Message 430 includes generic portions 432, 434, 436, 438 and 440. Message 430 includes tailored portions 442,444, 446, 448, 450, and 452. Audio portion 382 is assembled and delivered to client computer 320 along with the other portions of second message 380. Alternatively, audio portion 382 is delivered to client computer 320 as the audio components become available. As such, client computer 320 buffers the received audio so that message 430 is played without delays caused by waiting for additional audio. Alternatively, a separate generic portion containing background music is initially downloaded to client computer 320 and executed by client computer 320 until message 430 is completely downloaded to client computer 320.

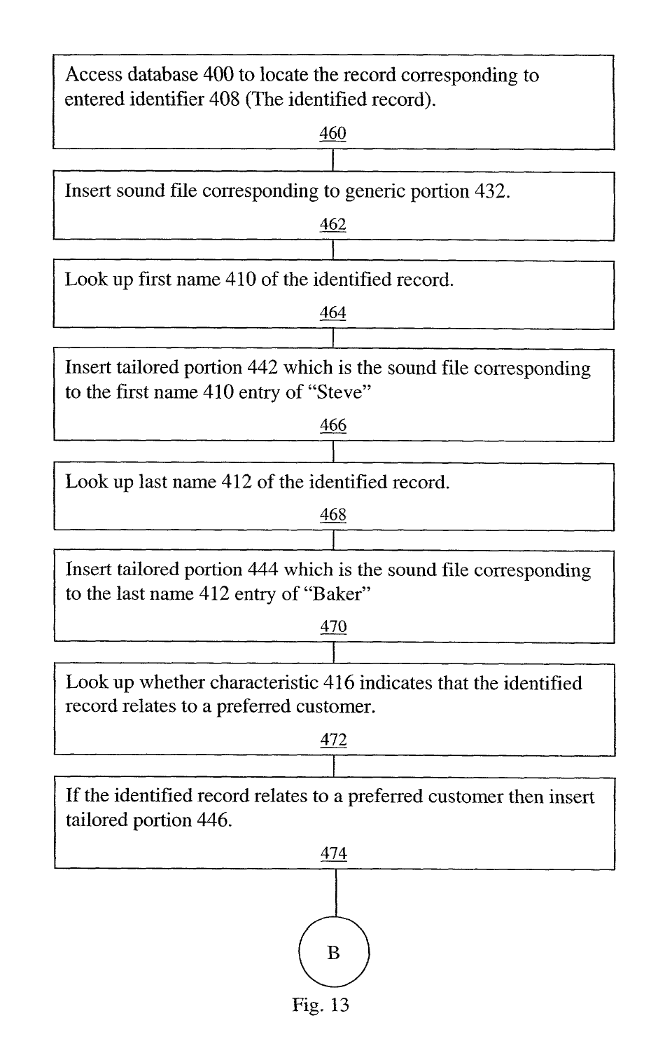

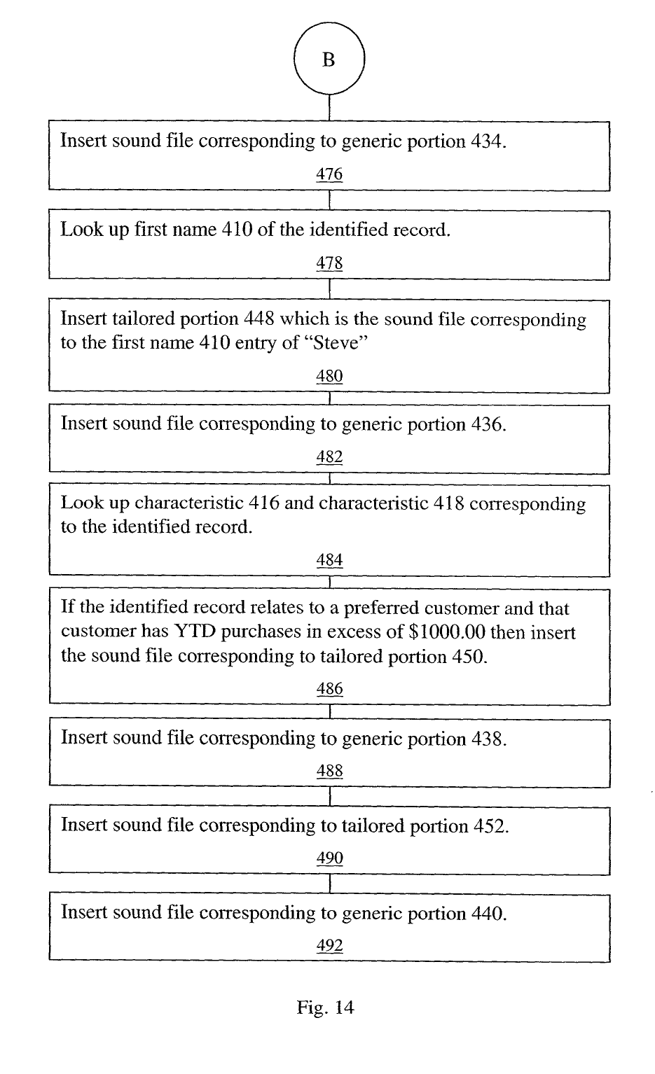

Referring to FIGS. 12-14, in one embodiment the value of identifier 408 received by server 310 was “0003.” Database record 406 contains the identifier 408 “0003.” As such, the message 430 is created based on the information about targeted individual 405 in database record 406. Database 400 is accessed, as represented by step 460, to retrieve the information contained in record 406, the record which corresponds to the entered identifier 408 of “0003.” As represented by step 462, message 430 includes generic portion 432 which is a recording of a simple greeting. Generic portion 432 is followed by tailored portions 442 and 444. Tailored portion 442 is a recording of the first name of targeted individual 405. Tailored portion 442 was selected in the following manner. The value of first name 410 is determined from record 406, as represented in step 464. Once the value of first name 410 is determined, tailored portion 442 which is a sound file corresponding to the first name entry “Steve” is inserted after generic portion 432, as represented by step 466. Similarly, the value of last name 412 is determined from record 406, as represented in step 468. Once the value of last name 412 is determined, tailored portion 444 which is a sound file corresponding to the last name entry “Baker” is inserted after tailored portion 444, as represented by step 470.

As represented by step 472, database record 406 is accessed to determine if targeted individual 405 is a preferred customer or not by checking the value of characteristic 416 in record 406. If targeted individual is a preferred customer, then the sound file corresponding to tailored portion 446 is inserted, as represented by step 474. Since Steve Baker is a preferred customer tailored portion 446 is inserted. Next, the sound file corresponding to generic portion 434 is inserted, as represented by step 476. Generic portion 434 includes marketing information related to the audience. Generic portion 434 is followed by tailored portion 448. Tailored portion 448 is a recording of the first name of targeted individual 405. Tailored portion 448 was selected in the following manner. The value of first name 410 is determined from record 406, as represented in step 478. Once the value of first name 410 is determined, tailored portion 448 which is a sound file corresponding to the first name entry “Steve” is inserted after generic portion 434, as represented by step 480. Alternatively, the system stores the value associated with first name 410 and populates all tailored portions using that value sequentially. Alternatively, the system stores a pointer to the sound file associated with the name.

As represented by step 482, the sound file corresponding to generic portion 436 is inserted. Message 430 next includes the capability of including tailored portion 450. Tailored portion 450 is included if targeted individual 405 is a preferred customer and has year-to-date purchases in excess of $1000.00, one thousand dollars. As such, characteristic 416 of record 406 is queried to determine if targeted individual is a preferred customer and characteristic 418 is queried to determine if the purchases credited to targeted individual 405 exceed $1000.00, one thousand dollars, as represented by step 484. If targeted individual 405 is a preferred customer and has purchased over $1000.00, one thousand dollars, then tailored portion 450 is inserted into message 430, as represented by step 486.

As represented by step 488, message 430 includes the sound file corresponding to generic portion 438. Message 430 further includes the sound file corresponding to tailored portion 452, as represented by step 490. Tailored portion 452 is determined in a variety of methods. In one embodiment, the value of tailored portion 452 is pre-assigned and a portion of the value of tailored portion 452 indicates whether targeted individual 405 is a preferred customer or not. In an alternative embodiment, the value of tailored portion is decided based upon the value of characteristics 416 and 418. Finally, as represented by step 492, the sound file corresponding to generic portion 440 is included in message 430.

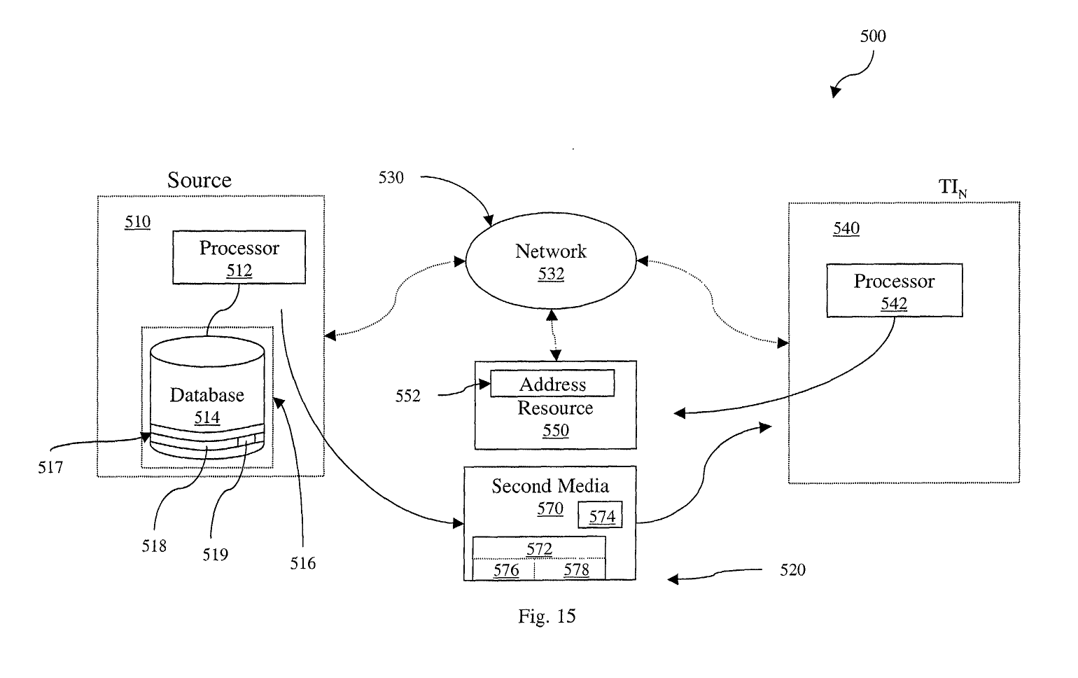

Referring to FIG. 15, an exemplary embodiment of a marketing system 500 of the present invention is shown. Marketing system 500 includes a source 510, a message 520, and a communication system 530. Source 510 includes a processor 512 and a database 514 being accessible by processor 512. In an exemplary embodiment processor 512 is part of a personal computer. Alternatively, processor 512 is a server computer. In an exemplary embodiment database 514 is stored in a memory 516 accessible by processor 512. As such, database 514 is stored on the same computer as processor 512, on a the same local area network as processor 512, or on a network accessible by processor 512.

Database 514 includes a plurality of records 517, each record pertaining to a separate targeted individual. For example, record (TI_{N}) 518 corresponds to target individual (TI_{N}) 540. Each record contains an identifier 519. Identifier 519 is unique to the targeted individual associated with the record. Alternatively, identifier 519 is unique to a particular group of which the targeted individual is a member. As such, each individual which is part of a specific group has the same identifier stored in their database record. Alternatively, identifier 519 is unique to each targeted individual, but identifier 519 includes information pertaining to the group or groups that the individual is associated therewith. For example, a first portion of identifier 519 is configured to represent group information while a second portion of identifier 519 is configured to be unique to the individual.

Communication system 530 is a network 532 that connects source 510 with the audience such as targeted individual (TI_{N}) 540. In one embodiment communication system 530 is a network of server computers, such as the Internet. Alternatively, communication system 530 is a local area network. Alternatively, communication system 530 is a cable network. Communication system 530 is connected to source 510 and the audience, such as targeted individual (TI_{N}) 540 through a physical connection. Examples include a telephone modem or cable modem. Alternatively, communication system 530 is connected to source 510 and the audience, such as targeted individual (TI_{N}) 540 through a wireless connection. An example of a wireless connection is a cellular connection similar to cellular phone technology.

Marketing system 500 includes a resource 550 connected to the communication system 530. Resource 550 provides information to the audience, such as targeted individual (TI_{N}) 540 and is capable of receiving input from the audience, such as targeted individual (TI_{N}) 540. Resource 550 is connected to communication system 530 and communicates with source 510 and targeted individual (TI_{N}) 540 over communication system 540. Alternatively, resource 550 is located within memory 516 which is accessible by processor 512.

In an exemplary embodiment, resource 550 includes an address 552 and is a web page which is accessible with a web browser through communication system 540. Alternatively, resource 550 a program which is accessible or downloadable across communication system 540. Alternatively, resource 550 is a CGI script, an Active Server Page, or other generated web page.

Referring to FIGS. 15-17, an illustrative embodiment is provided for the operation of marketing system 500. Information related to the audience including information related to targeted individual (TI_{N}) 540 is collected. For example, a bank supplies their customer list and customer information or a club might provide their membership list and membership information or a marketing company might supply their list of potential customers or customer information. A database 514 is created from the supplied information. In marketing system 500, each targeted individual, such as targeted individual 540, already knows their identifier. As such, the database records already include the appropriate identifier for each record.

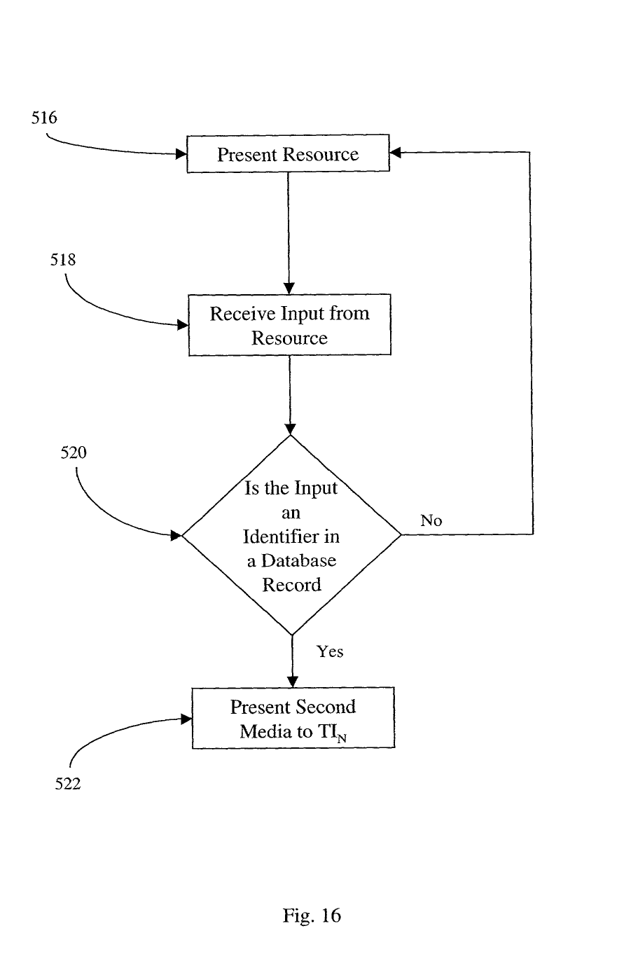

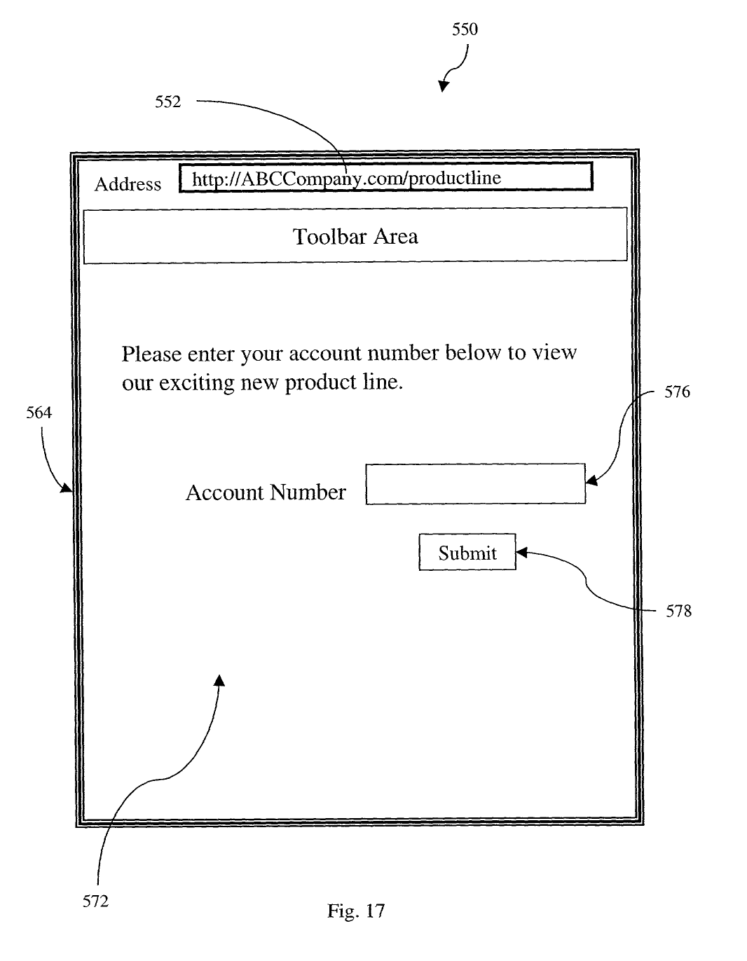

After database 514 has been created, a resource 550 is created. An example resource 550 is web page 572 which is displayable with a commercial web browser 564, as represented in FIG. 17. Targeted individual 540 receives an address 552 for resource 550 from their existing relationship with the company or bank. For example, a bank will notify its customers that they can check their account balances online at address 552. Targeted individual 540 enters address 552 into web browser 364 which is running on a processor 542. Processor 542 is connected to communication system 540. The web browser 564 communicates address 552 to communication system 540 which in turn redirects web browser 564 to resource 550 which has address 552. Targeted individual 540 is presented with the content of resource 550, as illustrated by step 516 of FIG. 16.

Once at resource 550, targeted individual 540 inputs identifier 519. The entered identifier is passed onto processor 512 through communication system 540, as illustrated in step 518. The entered identifier is then compared to the plurality of identifiers stored in database 514, as illustrated in step 520. If the identifier does not match one of the identifiers in database 514, resource 550 is presented to targeted individual 540 again. Resource 550 might further include a text message stating that the identifier was not verified. If the identifier matches one of the identifiers in database 514, marketing system 500 presents targeted individual 540 with a second media 570, as illustrated by step 522.

Second media 570 includes an audio component or portion 572. Alternatively, second media 570 includes an audio component or portion 572 and a visual component or portion 574. Audio portion 572 includes a generic component or portion 576 and a tailored component or portion 578. The combination of generic portion 576 and tailored portion 578 produces an audio message which is personalized to targeted individual 540. Both generic portion 576 and tailored portion 578 can be segmented into multiple sub-portions which are then interlaced to form the complete audio component 572 of second media 570.

Generic portion 576 and tailored portion 578 are created by recording an announcer reading the transcripts for each. The recordings are stored in memory 516 along with additional generic portions and tailored portions. It should be understood that generic portion 576 and tailored portion 578 correspond to recordings that were selected from a larger quantity of recordings because they corresponded to the second media 570 that is to be presented to targeted individual 540. Different tailored portions and possibly different generic portions would be selected for a second targeted individual. As such, second media 570 is created by selecting the appropriate generic portions 576 and tailored portions 578 for targeted individual 540.

While t he invention ha s been illustrated and described in detail in the drawings and foregoing description, such illustration and description is to be considered as exemplary and not restrictive in character, it being understood that only exemplary embodiments have been shown and described and that all changes and modifications that come within the spirit of the invention are desired to be protected.

I claim:

1. A marketing system for communicating with an audience including a targeted individual through a communication system, the marketing system, comprising:
a processor;
a database accessible by the processor and including data related to the targeted individual and an identifier;
a plurality of audio recordings accessible by the processor;
the processor adapted to present the targeted individual with a resource including an audio component in response to the presentment of the identifier by the targeted individual, the audio component including at least one generic portion and at least one tailored portion, the at least one generic portion including at least one audio recording selected from the plurality of audio recordings and configured to present the audience with a recording containing marketing information and the at least one tailored portion including at least one audio recording selected from the plurality of audio recordings configured based on at least a portion of the data in the database related to the targeted individual.

2. The marketing system of claim 1, wherein the audio component includes a first tailored portion corresponding to a name of the targeted individual included in the portion of data corresponding to the targeted individual and including a first audio recording selected from the plurality of audio recordings, the first audio recording including the name of the targeted individual.

3. The marketing system of claim 2, wherein the audio component includes a second tailored portion based on a first value of a first characteristic of the targeted individual included in the portion of data corresponding to the targeted individual.

4. The marketing system of claim 2, wherein the audio component excludes a second tailored portion based on a second value of a first characteristic of the targeted individual included in the portion of data corresponding to the targeted individual.

5. The marketing system of claim 1, wherein the resource is presented in response to the identifier being provided through a web page.

6. The marketing system of claim 5, wherein the processor is adapted to provide the identifier to the targeted individual in a first media.

7. The marketing system of claim 1, wherein the resource further includes a visual component, the visual component including a generic portion configured for the audience and a tailored portion configured based on at least a portion of the data in the database related to the targeted individual.

8. The marketing system of claim 7, wherein the audio component includes a first tailored portion corresponding to a name of the targeted individual included in the portion of data corresponding to the targeted individual and including a first audio recording selected from the plurality of audio recordings, the first audio recording including the name of the targeted individual.

9. The marketing system of claim 8, wherein the audio component includes a second tailored portion based on a first value of a first characteristic of the targeted individual included in the portion of data corresponding to the targeted individual.

10. The marketing system of claim 8, wherein the audio component excludes a second tailored portion based on a second value of a first characteristic of the targeted individual included in the portion of data corresponding to the targeted individual.

11. The marketing system of claim 7, wherein the visual component includes a first tailored portion corresponding to a first characteristic of the targeted individual included in the portion of data corresponding to the targeted individual.

12. A marketing system for communicating with a targeted individual, the marketing system, comprising:
a processor;
a database accessible by the processor and including data related to the targeted individual; and
a resource including an address and an input;
the processor adapted to present the targeted individual with a first media, the first media including the address of the resource and at least a first portion of the data in the database related to the targeted individual, the first portion including an identifier; and
the processor adapted to selectively present the targeted individual with a second media in response to the presentment of the identifier to the input of the resource, the second media including an audio message having at least one generic portion and at least one tailored portion, the at least one tailored portion configured based on at least a second portion of the data in the database related to the targeted individual.

13. The marketing system of claim 12, wherein the audio message includes a first tailored portion corresponding to a name of the targeted individual included in the second portion of data corresponding to the targeted individual, the first tailored portion including an audio recording of the name the targeted individual.

14. The marketing system of claim 13, wherein the audio message includes a second tailored portion based on a first value of a first characteristic of the targeted individual included in the second portion of data corresponding to the targeted individual.

15. The marketing system of claim 13, wherein the audio message excludes a second tailored portion based on a second value of a first characteristic of the targeted individual included in the second portion of data corresponding to the targeted individual.

16. The marketing system of claim 12, wherein the identifier is not a component of the address of the resource.

17. The marketing system of claim 12, wherein the second media further includes a visual message, the visual message including a generic portion configured for the audience and a tailored portion configured based on at least a portion of the data in the database related to the targeted individual.

18. The marketing system of claim 17, wherein the audio message includes a first tailored portion corresponding to a name of the targeted individual included in the second portion of data corresponding to the targeted individual, the first tailored portion including an audio recording of the name the targeted individual.

19. The marketing system of claim 18, wherein the audio message includes a second tailored portion based on a first value of a first characteristic of the targeted individual included in the second portion of data corresponding to the targeted individual.

20. The marketing system of claim 18, wherein the audio message excludes a second tailored portion based on a second value of a first characteristic of the targeted individual included in the second portion of data corresponding to the targeted individual.

21. A method for marketing to a targeted individual, the method comprising the steps of:
storing data related to the targeted individual;
providing the targeted individual with a first media including an address and an identifier;
receiving from the targeted individual the identifier;
providing the targeted individual with a second media, the second media including an audio message having at least one generic portion and at least one tailored portion, the at least one tailored portion configured based on the data related to the targeted individual.

22. The method of claim 21, wherein the audio message includes a first tailored portion corresponding to a name of the targeted individual, the name included in the data related to the targeted individual, the first tailored portion including a first audio recording of the name selected from a plurality of audio recordings.

23. The method of claim 22, wherein the audio message includes a second tailored portion corresponding to a first value of a first characteristic of the targeted individual, the first characteristic included in the data related to the targeted individual, the second tailored portion including a second audio recording selected from the plurality of audio recordings.

24. The method of claim 21, wherein the second media further includes a visual component.

25. The method of claim 24, wherein the audio message includes a first tailored portion corresponding to a name of the targeted individual, the name included in the data related to the targeted individual, the first tailored portion including a first audio recording of the name selected from a plurality of audio recordings.

26. The method of claim 25, wherein the audio message includes a second tailored portion corresponding to a first value of a first characteristic of the targeted individual, the first characteristic included in the data related to the targeted individual, the second tailored portion including a second audio recording selected from the plurality of audio recordings.

27. A marketing system for communicating with a targeted individual, the marketing system, comprising:
a processor;
a database accessible by the processor including data related to the targeted individual and an identifier;
a resource including an input; and
the processor adapted to present the targeted individual with a media, the media including a visual component and an audio component, the audio component having at least one generic portion configured to present the audience with marketing information and at least one tailored portion, the at least one tailored portion configured based on at least a portion of the data in the database related to the targeted individual.

28. The marketing system of claim 27, wherein the media is presented in response to the identifier being provided to the input of the resource.

29. The marketing system of claim 27, wherein the audio component includes a first tailored portion corresponding to a name of the targeted individual included in the portion of data corresponding to the targeted individual, the first targeted portion including an audio recording of the name of the targeted individual.

30. The marketing system of claim 29, wherein the audio message includes a second tailored portion based on a first value of a first characteristic of the targeted individual included in the portion of data corresponding to the targeted individual.

31. The marketing system of claim 29, wherein the audio message excludes a second tailored portion based on a second value of a first characteristic of the targeted individual included in the portion of data corresponding to the targeted individual.

32. A marketing system for communicating with an audience of targeted individuals, including a first targeted individual and a second targeted individual, the marketing system comprising:
a processor connected to a communication system; and
a database accessible by the processor including data related to the first targeted individual and a first identifier and data related to the second targeted individual and a second identifier; and
a resource including an input;
the processor adapted to present the first targeted individual with a media configured for the first targeted individual, the media including an audio component, the audio component having an at least one generic portion configured to present the audience with marketing information and an at least one tailored portion, the at least one tailored portion configured based on at least a portion of the data in the database related to the first targeted individual; and
the processor further adapted to present the second targeted individual with a media configured for the second targeted individual, the media including an audio component, the audio component having an at least one generic portion configured to present the audience with marketing information and an at least one tailored portion, the at least one tailored portion configured based on at least a portion of the data in the database related to the second targeted individual.

33. The marketing system of claim 32, wherein the media configured for the first targeted individual is presented to the first targeted individual in response to the first identifier being provided to the input of the resource and wherein the media configured for the second targeted individual is presented to the second targeted individual in response to the second identifier being provided to the input of the resource.

34. The marketing system of claim 33, wherein the media presented to the first targeted individual includes a first tailored portion including an audio recording corresponding to a value of a characteristic of the first targeted individual, the value of the characteristic being determined from the data in the database related to the first targeted individual.

35. The marketing system of claim 33, wherein the media presented to the second targeted individual includes a first tailored portion including an audio recording corresponding to a value of a characteristic of the second targeted individual, the value of the characteristic being determined from the data in the database related to the second targeted individual.

36. A method for marketing to a targeted individual, the method comprising the steps of:
storing data related to the targeted individual including an identifier;
receiving from the targeted individual the identifier;
verifying the identifier by comparing the identifier to a database containing a plurality of known identifiers;
providing the targeted individual with a resource, the resource including a visual component and an audio message having at least one generic portion configured to present the targeted individual with marketing information and at least one tailored portion, the at least one tailored portion configured based on a portion of data stored in the database and related to the targeted individual.

37. The method of claim 36, wherein the audio message includes a first tailored portion corresponding to a name of the targeted individual, the name included in the portion of data related to the targeted individual.

38. The method of claim 37, wherein the audio message includes a second tailored portion corresponding to a first value of a first characteristic of the targeted individual, the first characteristic included in the portion of data related to the targeted individual.
